(19) United States
(12) Patent Application Publication
(10) Pub. No.: US 2015/0364110 A1
(43) Pub. Date: Dec. 17, 2015

(54) DISPLAY DEVICE

(71) Applicants: Inventec (Pudong) Technology Corporation, Shanghai City (CN); Inventec Corporation, Taipei City (TW)

(72) Inventors: LUNG-HSUN SONG, Taipei City (TW); CHUN-YUAN HUANG, Taipei City (TW); CHUN-CHI LIN, Taipei City (TW)

(21) Appl. No.: 14/606,754

(22) Filed: Jan. 27, 2015

(30) Foreign Application Priority Data
Jun. 12, 2014 (CN) 201410260459.5

(51) Int. Cl. G09G 5/00

(52) U.S. Cl. CPC G09G 5/006; G09G 2370/16; G09G 2300/04

(57) ABSTRACT

A display device is disclosed in this disclosure. The disclosed display device comprises a first display module and a wireless communication module. The first display module has a first lateral surface and a recess opening in the first lateral surface. The wireless communication module may be optionally disposed in the recess to couple to the first display module. The wireless communication module obtains electric power from the first display module and sends image frames to the first display module to control the first display module to display the image frames when coupled to the first display module. When the wireless communication module is disposed in the recess, a second lateral surface of the wireless communication module is co-plane with the first lateral surface.

### RELATED APPLICATIONS

This application claims priority to China Application Serial Number 201410260459.5, filed Jun. 12, 2014, which is incorporated by reference herein in its entirety.

### TECHNICAL FIELD

The present disclosure relates to a display device, and more particularly, to a display device applying wireless communication technology.

### BACKGROUND

Display devices have a wide variety of usage in our daily lives such as displaying data, entertainment, and so on. However, it is inconvenient that the common display device needs to connect to a video provider as a video source.

Besides, taking the portable computer for an example, generally the users would like to show the information in their portable computers with a bigger external display device. But they usually need to use a flash disk to transfer data, or to use an signal cable to connect an external display device to a portable computer, or to prepare other transmission devices to transfer data to the device connected to the external display device. These extra devices (flash disk, signal cable, other transmission devices) may take huge space or be lost easily. Therefore, how to provide a convenient video displaying device or interface is an urgent problem.

### SUMMARY

In consideration of the aforementioned urgent problem, the present disclosure offers a display device with a wireless communication module to receive video streaming (or image frames), and the default display module is closely integrated with the wireless communication module to be a single design when the wireless communication module is disposed on it. The display device can receive the video streaming via wireless communication and display the video streaming on the default display module. Moreover, the wireless communication module can be unplugged from the default display module and plugged on other external display device with the corresponding data transferring terminal if necessary. The wireless communication module can be also unplugged from other external device and plugged back to the default display module.

According to the present disclosure or a plurality of embodiments, the disclosed display device comprises a first display module and a wireless communication module. The first display module has a first lateral surface and a recess opening in the first lateral surface. The wireless communication module may be optionally disposed in the recess to couple to the first display module. The wireless communication module obtains electric power from the first display module and sends image frames to the first display module to control the first display module to display the image frames when coupled to the first display module. When the wireless communication module is disposed in the recess, a second lateral surface of the wireless communication module is co-plane with the first lateral surface.

According to the display device of the present disclosure, the wireless communication module is closely integrated with the first display module to be a single design when inserted into the first display module. The display device receives the video streaming via wireless communication and display the video streaming on the first display module. The wireless communication module can be unplugged from the first display module and plugged to the second display module if necessary. The wireless communication module can be also unplugged from the second display device and plugged back to the first display module when finishing the job.

The content of the present disclosure set forth and the embodiment hereinafter are used to demonstrate and explain the present disclosure's spirit and theory, and to provide further explanations of the claim.

### BRIEF DESCRIPTION OF THE DRAWINGS

The present disclosure will be more fully understood from the detailed description given hereinbelow, along with the accompanying drawings as follows:

FIG. 1A and FIG. 1B are schematic views of a display device according to an embodiment of the present disclosure.

FIG. 2 is a functional block diagram of the first display module according to an embodiment of the present disclosure.

FIG. 3 is a functional block diagram of the wireless communication module according to an embodiment of the present disclosure.

FIG. 4 is a functional block diagram of the control module according to an embodiment of the present disclosure.

### DETAILED DESCRIPTION

The features and advantages of the present disclosure are described below in great detail through the following embodiment, and the content of the detailed description is sufficient for persons skilled in the art to understand the technical content of the disclosure and to implement the disclosure there accordingly. Based upon the content of the specification, the claims, and the drawings, persons skilled in the art can easily understand the relevant objectives and advantages of the disclosure. And the following embodiment is a further description of the disclosure.

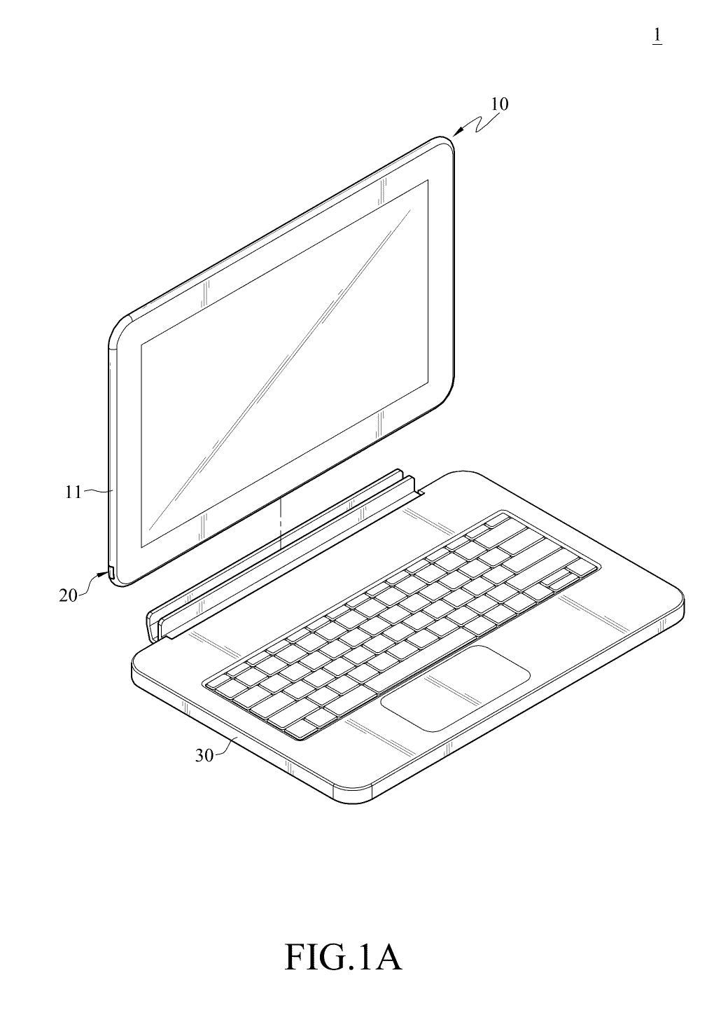

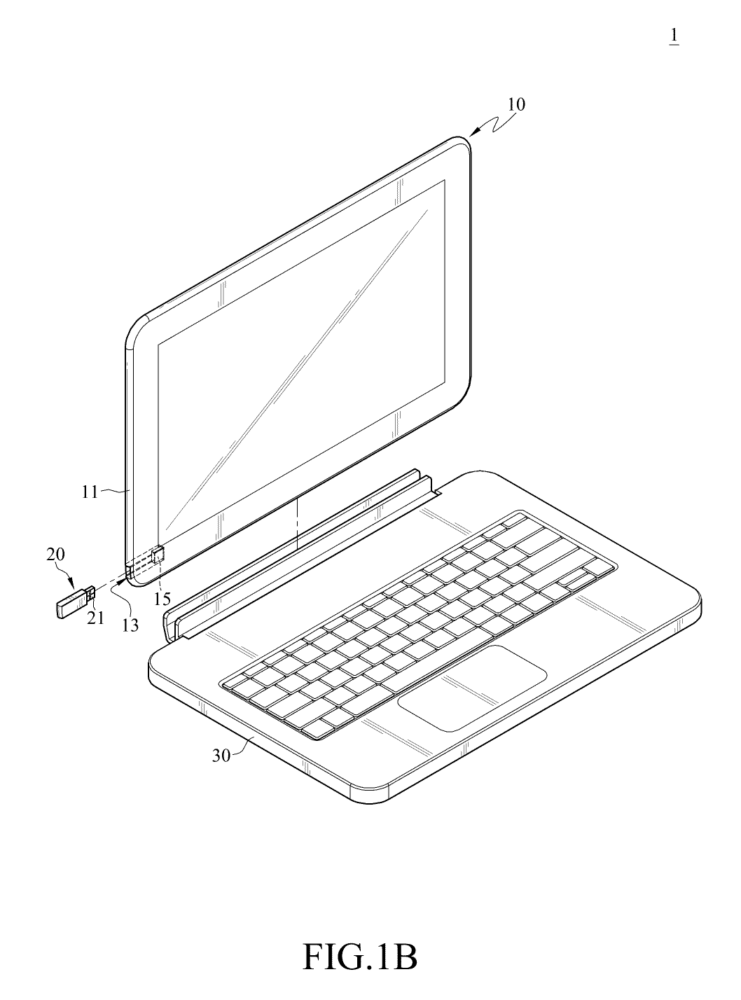

FIG. 1A and FIG. 1B are schematic views of a display device according to an embodiment of the present disclosure. According to FIG. 1A, the described display device 1 comprises a first display module 10 and a wireless communication module 20. The first display module 10 has a first lateral surface 11 and a recess opening 13 showing in FIG. 1B. The described recess opening 13 has an opening on the first lateral surface 11. According to the example in FIG. 1A and FIG. 1B, the first lateral surface 11 refers to the left side. However, the first lateral surface 11 can also refer to another side, even the front or back side of the first display module according to the present disclosure. The first display module 10 can be a flat panel display such as Liquid Crystal Display (LCD), Light Emitting Diode display (LED display), or other flat panel display device in the implementation. The first display module 10 is controlled by the wireless communication module 20 and display video when the first display module 10 is coupled to wireless communication module 20.

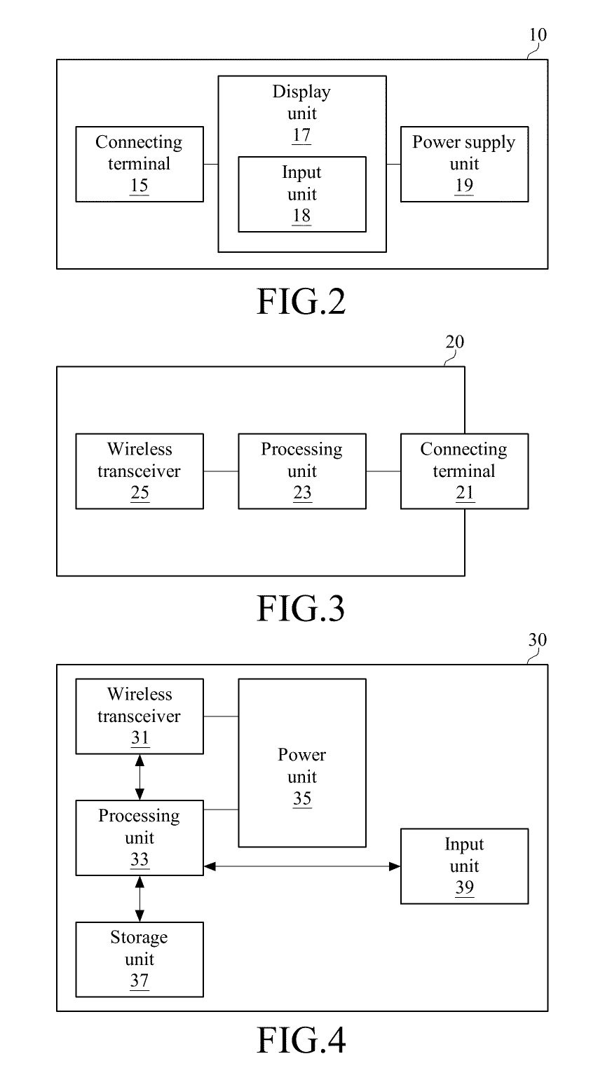

FIG. 2 is a functional block diagram of the first display module according to an embodiment of the present disclosure. According to FIG. 2, the first display module 10 comprises a connecting terminal 15, a display unit 17, and a power supply unit 19. The connecting terminal 15 is coupled to the display unit 17. The connecting terminal 15 is also coupled to the power supply unit 19 because the display unit 17 is coupled to the power supply unit 19.

The function of the connecting terminal 15 is for connecting to the wireless communication module 20. In this structure, please refer to FIG. 1B, the connecting terminal 15 is disposed in the recess opening 13. The connecting terminal 15 can set up several connectors according to the needs. The wireless communication module 20 can couple to multiple units in the first display module 10 through the connecting terminal 15 when the wireless communication module 20 is plugged to the recess opening 13 and couple to the connecting terminal 15. Therefore, the wireless communication module 20 can obtain electric power from the power supply unit 19 through the connecting terminal 15, so that the wireless communication module 20 does not need a power supply for the wireless communication module 20 and reduces the size. Besides, the wireless communication module 20 can transmit video streaming to the display unit 17 for displaying via the connecting terminal 15. According to the present disclosure, for example, the connecting terminal 15 can be a Universal Serial Bus (USB), High-Definition Multimedia Interface (HDMI), or other connecting terminal suitable for the video signal transmission interface.

When the wireless communication module 20 is coupled to the first display module 10 and multiple units therein through the connecting terminal 15, the display unit 17 can display the image frames received from the wireless communication module 20. Specifically speaking, the display unit 17 can be an electronic paper, LCD, or other display panel. In some specific embodiments, the first display module 10 does not comprise any image processing unit. In these embodiments, the first display module 10 relies on the wireless communication module 20 to process images. In some other embodiments, the first display module 10 can have its own image processing units (not pictured in the drawings) and the wireless communication module 20 is only for wireless communication or assisting with processing images.

Besides, in some embodiments, the display unit 17 can further cooperate with a input unit 18. The input unit 18 can be a resistive touch panel, capacitive touch panel, projective capacitive touch panel, electromagnetic touch panel, button, and so on. Therefore, users can use the display device 1 via operating on the input unit 18 in the first display module 10. When the input unit 18 receives the operations from the user, the input unit 18 can transmit single or multiple corresponding operation signals to the wireless communication module 20 via the connecting terminal 15. The wireless communication module 20 can directly handle the received operation signals or transmit them via wireless communication.

A power supply unit 19 is for supplying power to the display unit 17 or the wireless communication module 20 via the connecting terminal 15. In the implementation, the power supply unit 19 can be an AC/DC converter or a battery.

According to both FIG. 1A and FIG. 1B, in this embodiment of the present disclosure, the wireless communication module 20 is pluggable to the recess opening 13 for physically connecting and coupled to the first display module 10. More specifically, the connecting terminal 15 is disposed in the recess opening 13 of the first display module 10. And the wireless communication module 20 also has a connecting terminal 21 corresponding to the connecting terminal 15. The wireless communication module 20 is coupled to the first display module 10 when the wireless communication module 20 is disposed in the recess opening 13 and the connecting terminal 21 connects to the connecting terminal 15.

FIG. 3 is a functional block diagram of the wireless communication module according to an embodiment of the present disclosure. According to FIG. 3, the wireless communication module 20 may comprise a connecting terminal 21, a processing unit 23 and a wireless transceiver 25. The connecting terminal 21 and the wireless transceiver 25 are coupled to the processing unit 23. The connecting terminal 21 shown in FIG. 1B is for matching with the connecting terminal 15. And the wireless communication module 20 is coupled to the first display module 10 via the connecting terminal 21 and the connecting terminal 15. The connecting terminal 21 is, for example, a USB, a HDMI, or other connecting terminal suitable for the video signal transmission interface.

When the wireless communication module 20 is coupled to the first display module 10, the processing unit 23 is coupled to the display unit 17 via the connecting terminal 21 and the connecting terminal 15. Thereby, the display unit 17 can display single or multiple image frames processed by the processing unit 23. According the present disclosure, the processing unit can be a chip with the image processing function.

The wireless transceiver 25 is for receiving the image frames or video streaming to be displayed on the first display module 10. In the implementation, the wireless transceiver 25 can use Bluetooth, IEEE 802.11a/b/g/n, and so on, standards to receive data (image frames or video streaming). When the wireless transceiver 25 receives the data, the wireless transceiver 25 transmits the data to the processing unit 23 for processing. In some embodiments, the wireless transceiver 25 can transmit single or multiple operation signals received from the input unit 18 to the remote processing device when the first display module 10 has the input unit 18.

According to FIG. 1A, the display device can further comprise a control module 30. The control module 30 can build a wireless communication path with the wireless communication module 20. Besides, the control module 30 can transmit video streaming (multiple packets consisted of multiple image frames) to the wireless communication module 20. Therefore, the first display module 10 and the wireless communication module 20 can receive and display image frames wirelessly.

FIG. 4 is a functional block diagram of the control module according to an embodiment of the present disclosure. According to FIG. 4, the control module 30 may comprise a wireless transceiver 31, a processing unit 33, and a power unit 35. The power unit 35 is separately coupled to the wireless transceiver 31 and the processing unit 33 for providing power.

The wireless transceiver 31 can be used to build a wireless communication path between the aforementioned wireless transceiver 25. In an embodiment, the wireless transceiver 31 and the wireless transceiver 25 are connecting to a wireless access point separately (not pictured in the drawings). In other words, the wireless transceiver 31 and the wireless transceiver 25 are belonging to the same local network. Thereby, the wireless transceiver 31 can transmit the data (image frames of a video or screens of an executing program) to the wireless transceiver 25.

In another embodiment, the wireless transceiver 31 can directly build a connection to the wireless transceiver 25 without other device. For example, when the wireless transceiver 31 is activated because of the booting of the control module 30, the wireless transceiver 31 will automatically emit web beacons for other devices to search or to search for other web beacons. The wireless transceiver 25 is enabled after the wireless communication module 20 and the first display module 10 are electrically connected to each other. The wireless transceiver 25 searches web beacons or emits web beacons so as to try to connect to the wireless transceiver 31 via Wi-Fi, Bluetooth, or other wireless communication protocols.

The processing unit 33 is coupled to the wireless transceiver 31 and providing images frames to be displayed on the first display module 10, and then controlling the wireless transceiver 31 to send the image frames. In an embodiment, the wireless transceiver 31 can receive multiple video streaming from the network and the processing unit 33 can select one video streaming from those video streaming to re-compress or adjust the frame rate, and then send to the wireless transceiver 25 from the wireless transceiver 31. According to the present disclosure, the processing unit 33 can be an Application-Specific Integrated Circuit (ASIC), Advanced RISC Machine (ARM), Central Processing Unit (CPU), single chip controller, or other device suitable for executing arithmetic and control instructions.

In another embodiment, the control module 30 further comprises a storage unit 37 coupled to the processing unit 33. The processing unit 33 can select a video streaming from the storage unit 37 and then send to the wireless transceiver 25 via the wireless transceiver 31. Otherwise, if most of the images saved in the storage unit 37 are static, the processing unit 33 converts the saved images into multiple sequential image frames and send to the wireless transceiver 25 via the wireless transceiver 31.

In another embodiment, the control module 30 can further comprise an input unit 39 coupled to the processing unit 33. The input unit 39 can receive multiple instructions from the users and the processing unit 33 can adjust the content of the video streaming or image frames according to these instructions. The aforementioned input unit 39 can be a mouse, keyboard, touch panel, trackball, voice input device, or other device suitable for receiving instructions.

In an embodiment of the present disclosure, when the user wants to use a bigger second display module (not pictured in the drawings), he only needs to unplug the wireless communication module 20 from the first display module 10 and plug the wireless communication module 20 to the second display module. So the second display module can present the video streaming or image frames receiving from the control module 30. And the user can unplug the wireless communication module 20 and plug it back to the first display module when the second display module is no longer needed.

In another embodiment, the first user of two users can use the first display module 10 with the input unit 18(touch screen) to input data, and the second user can use the input unit 39 of the control module 30 to input data. It is more convenient for multiple users with an assisting computer software.

According to the display device of the present disclosure, the wireless communication module is closely integrated with the first display module to be a single design when inserted into the first display module. The display device receives the video streaming via wireless communication and displays it on the first display module. The wireless communication module can be unplugged from the first display module and plugged to the second display module if necessary. It can be also unplugged from the second display device and plugged back to the first display module when finishing the job.

What is claimed is:

1. A display device, comprising:
a first display module having a first lateral surface and a recess, an opening of the recess on the first lateral surface; and
a wireless communication module, pluggably disposed in the recess to couple to the first display module, for obtaining electric power from the first display module when the wireless communication module is electrically connected to the first display module, and for sending an image frame to the first display module to control the first display module to display the image frame when wirelessly receiving the image frame;
wherein when the wireless communication module is disposed in the recess, a second lateral surface of the wireless communication module is co-plane with the first lateral surface.

2. The display device of claim 1, further comprising a control module comprising:
a first wireless transceiver for building a wireless communication path with the wireless communication module to send the image frame; and
a first processing unit coupled to the first wireless transceiver for processing the image frame and controlling the first wireless transceiver to send the image frame.

3. The display device of claim 2, wherein the first display module comprises:
a first connecting terminal, coupled to a power unit, for connecting to the wireless communication module; and
a display unit for being controlled by the wireless communication module to display the image frame.

4. The display device of claim 3, wherein the wireless communication module comprises:
a second connecting terminal for connecting to the first display module;
a second processing unit coupled to the second connecting terminal, obtaining electric power by coupled to the first display module via the second connecting terminal, and connecting to the first display module via the second connecting terminal; and
a second wireless transceiver coupled to the second processing unit for building the wireless communication path between the second processing unit and the control module to receive the image frame;
wherein the second processing unit transmits the image frame to the first display module for displaying when receiving the image frame from the second wireless transceiver.

5. The display device of claim 4, wherein each of the first connecting terminal and the second connecting terminal is selected from the group consisting of a Universal Serial Bus (USB) and a High-Definition Multimedia Interface (HDMI).

6. The display device of claim 3, wherein the first display module further comprises an input unit coupled to the first connecting terminal for receiving an operation signal, and the received operation signal is transmitted from the first connecting terminal to the wireless communication module and then transmitted from the wireless communication module to the control module.

7. The display device of claim 6, wherein the control module adjusts the image frame according to the operation signal when receiving the operation signal.

8. The display device of claim 6, wherein the input unit is for receiving an operation to obtain an operation signal.

9. The display device of claim 3, wherein the first display module is a flat panel display.
